(19) United States
(12) Patent Application Publication
(10) Pub. No.: US 2015/0173072 A1
(43) Pub. Date: Jun. 18, 2015

(54) METHOD AND APPARATUS FOR CONTROLLING RESPONSES FROM TWO-WAY RADIO SUBSCRIBERS

(71) Applicant: MOTOROLA SOLUTIONS, INC., SCHAUMBURG, IL (US)

(72) Inventor: Lars Henrik Frederiksen, Vedbaek (DK)

(21) Appl. No.: 14/402,762

(22) PCT Filed: May 10, 2013
(86) PCT No.: PCT/US2013/040563

§ 371 Date: Nov. 21, 2014

(30) Foreign Application Priority Data
Jun. 1, 2012 (GB) 1209804.2

(51) Int. Cl. H04W 72/04; H04W 4/06

(52) U.S. Cl. CPC H04W 72/0446; H04W 4/06

(57) ABSTRACT

A method and apparatus for controlling responses from mobile communication devices in a two-way radio communication system are provided. An infrastructure provides a multicast transmission, for transmission in a first time interval to members of a group of mobile communication devices. The infrastructure assigns a second time interval for at least a subgroup of the members to transmit to the infrastructure with reserved access, and assigns the reserved access timeslots. The infrastructure also assigns a third time interval, for members of the group to transmit to the infrastructure using random access. The second and third time intervals may be separated by other signaling, such as re-transmission by the infrastructure of parts of the multicast transmission. The selection and setting of time intervals may be based on information provided by a transmitter. A mobile communication device is also provided.

### FIELD OF THE DISCLOSURE

The present disclosure relates generally to two-way radio communication systems, and more particularly to controlling responses received from subscribers in a two-way radio system.

### BACKGROUND

A typical two-way radio system includes an infrastructure comprising base stations. Two-way radios either communicate with each other directly or through the base stations of the infrastructure. Two-way radio communication systems such as TETRA allow ‘talk groups’ of two-way radios to be set up. Such groups may typically comprise from three to twenty members, but may comprise more than a hundred members. A member of a talk group may place a call to all other members of the group. In addition, a ‘dispatcher’ may use the infrastructure of the system to place a call or to send data to all the members of the group.

When a call or data communication is sent from a base station of a two-way radio communication system to members of a talk group, the members may provide various responses. In one typical scenario, each member of the talk group will at least send an acknowledgement message to the base station, to confirm receipt of the call or data communication. Henceforth the term ‘call’ will be used to describe both voice calls and data communications, which are sometimes also referred to as a ‘connection’.

Two-way radio systems typically provide a channel on which responses from members of a group may be transmitted to the infrastructure. The channel will allow any member of the group to communicate with a base station using ‘random access’. This means that any member of the group is allowed to initiate a communication to the base station in one of many time slots that are available on the channel, which may be a ‘control channel’ or a ‘traffic channel’. One issue faced by such systems is that it is difficult to predict exactly when any given member of the group will wish to transmit to the base station, or be technically ready and able to transmit to the base station. When many members of a talk group wish to send acknowledgement messages to a base station using random access, they will try to send the messages at widely varying times. However, a significant proportion of the attempts by the members to transmit on the channel will clash with attempts by other members of the group to use the same random access time slot on the channel at the same time.

In systems such as TETRA, a success rate of first attempts by two-way radios to transmit to the infrastructure on the random access channel may be as low as 35%. When transmissions from two different members of the group coincide, a common result is that neither transmission is successfully received by the infrastructure. As a consequence, both members will need to make a second attempt at communicating over the random access channel. In some instances, the stronger of the competing signals can be received, and the other attempt at transmission in the same timeslot appears as noise. However, this outcome cannot be relied upon. If a group with, for example, one hundred members should try to use the random access channel to respond to one communication that is sent to them all at the same time, the proportion of members that succeed in responding may be very low.

To address this situation in known systems, the length of a time window in which random access is permitted may be increased. This provides additional time for members of the group to respond on the random access channel to any transmission from the infrastructure. Group members who are not successful at their first attempt to transmit to the infrastructure on the random access channel will then have additional time in which to make further attempts. This known approach is not a complete solution. For example, there will be a significant time period before acknowledgments have been received from all the members, and therefore a significant time before new signaling can be provided from the infrastructure. If even just one member does require re-transmission of part of the original transmission, there is a consequential delay in the infrastructure re-transmitting the part of the original transmission that is needed.

U.S. Pat. No. 7,013,157 provides a method for ensuring acknowledgement for multicast services in a two-way radio communication system. The disclosed approach is to select a designated receiver, as an indicator of whether a message from the infrastructure has been received successfully. Thus the approach of U.S. Pat. No. 7,013,157 is to rely on a message getting through to just one member of a talk group. Validation of successful receipt by that single member is taken as a substitute for acknowledgments from all the members of the group. If the infrastructure does not receive an acknowledgment from the single member, then the multicast message may be re-transmitted to the entire group. The re-transmission may identify a new, different receiver as the ‘designated’ receiver. The infrastructure will then await an acknowledgement from the newly designated receiver. In a two-way radio system, the different subscribers will usually have different coverage. Selecting a single subscriber as an indicator of success will seldom be a good approach, because no one subscriber is a reliable indicator of receipt by all of the subscribers.

Accordingly, there is a need for an improved method and apparatus for managing responses received from subscribers in a two-way radio system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a two-way radio communication system in accordance with an embodiment.

FIG. 2 is a flowchart of a method of controlling responses from mobile communication devices in accordance with some embodiments.

FIG. 3 is a flowchart of a method of assigning time intervals in accordance with some embodiments.

FIG. 4 is a schematic of the timing of signal transmission periods in accordance with some embodiments.

FIG. 5 is a schematic of the content of a multicast signal transmitted in accordance with some embodiments.

FIG. 6 is a schematic of the timing of signal transmission periods in accordance with another embodiment.

FIG. 7 is a block diagram of a two-way radio communication system in accordance with an embodiment in which the group is divided into subgroups.

FIG. 8 is a schematic of the timing of signal transmission periods in accordance with an embodiment.

FIG. 9 shows a method for setting and adjusting time intervals in accordance with an embodiment.

FIG. 10 is a schematic of the timing of signal transmission periods in accordance with an embodiment.

FIG. 11 is a schematic illustrating a mobile communication device in accordance with an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method of controlling responses from mobile communication devices in a two-way radio communication system is provided. The two-way radio communication system comprises an infrastructure. In accordance with the method, the infrastructure provides a multicast transmission for transmission to members of a group of mobile communication devices, and assigns a first time interval, for transmission of the multicast transmission to members of the group. The infrastructure also assigns a second time interval for the members of the group to transmit to the infrastructure, and assigns reserved access timeslots in the second time interval to members of the group, the second time interval occurring after the first time interval. The infrastructure also assigns a third time interval, for members of the group to transmit to the infrastructure using random access, the third time interval occurring after the second time interval.

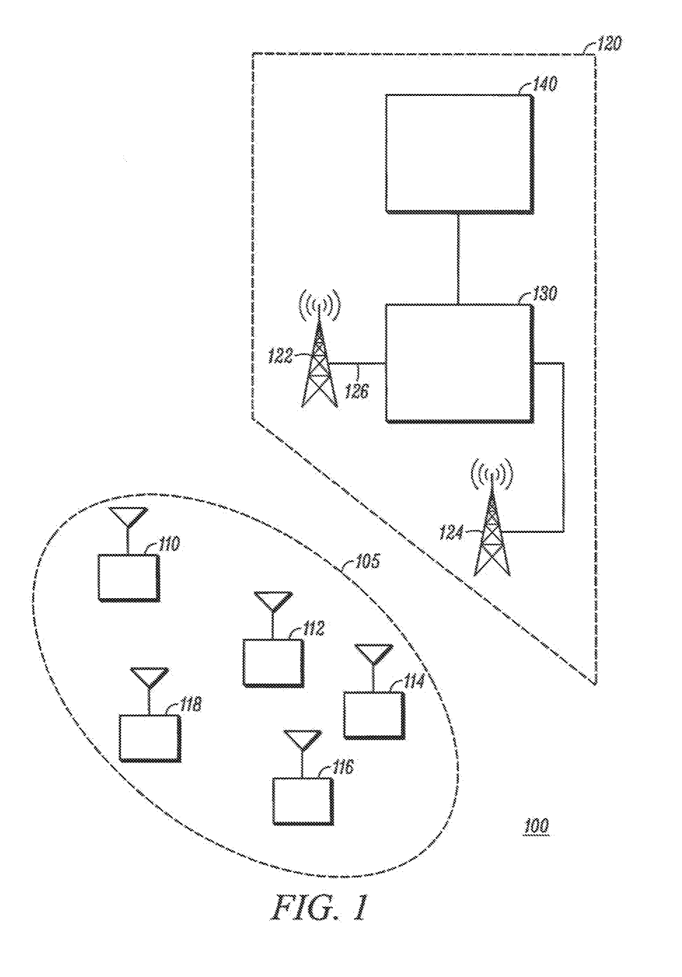

FIG. 1 is a block diagram of a two-way radio communication system 100 in accordance with an embodiment.

A group 105 or ‘talkgroup’ of mobile communication devices is generally indicated by the dotted oval shown on FIG. 1. Mobile communication devices 110, 112, 114, 116 and 118 are members of group 105. Each of mobile communication devices 110, 112, 114, 116 and 118 is operable to receive and respond to multicast transmissions from an infrastructure 120 of the two-way radio communication system 100. The multicast transmissions may comprise SD and/or packet data messages. The transmissions may comprise a talkgroup based ‘call-out’ like service. Any members wishing to respond positively to such a call out needs to transmit information back to the infrastructure 120.

Infrastructure 120 comprises various elements within the dotted rectilinear region at the upper right of FIG. 1. First base station 122 and second base station 124 form part of infrastructure 120. Link 126 connects base station 122 to transmitter 130. Transmitter 130 is connected to management module 140. In an embodiment in which two-way radio communication system 100 is a TETRA system, then management module 140 can be the Switching and Management Infrastructure (SwMI) of the TETRA infrastructure. Each of mobile communication devices 110, 112, 114, 116 and 118 is then a mobile station operating as part of a TETRA talkgroup.

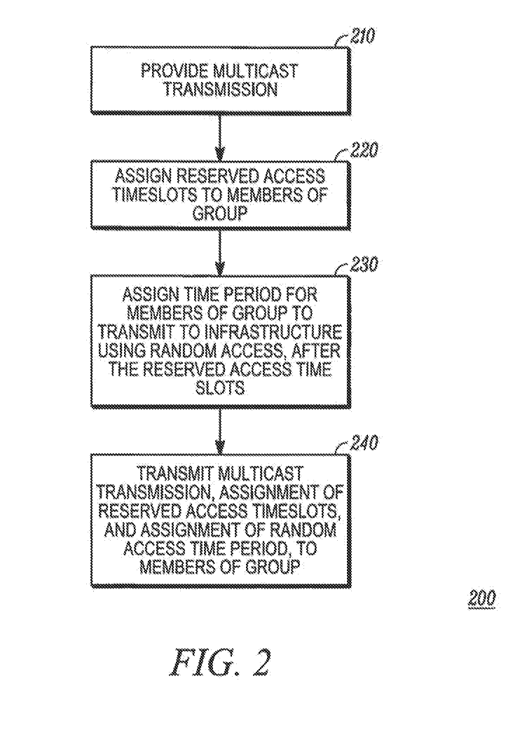

FIG. 2 is a flowchart of a method 200 of controlling responses from mobile communication devices 110, 112, 114, 116 and 118, in accordance with some embodiments. In operation, transmitter 130 may provide, at 210, a multicast communication for transmission to all of mobile communication devices 110, 112, 114, 116 and 118, i.e. to the members of group 105. At 220, infrastructure 120 also assigns reserved access timeslots to the members of the group 105, for the members to use for transmissions to the infrastructure 120 after transmission of the multicast transmission by the infrastructure 120. At 230, infrastructure 120 also assigns a time period, for the members of the group 105 to transmit to the infrastructure 120 using random access after the reserved access time slots. At 240, transmission of the multicast transmission to the members of group 105 may follow, together with transmission of the assignment of reserved access timeslots and assignment of the random access time period.

The multicast transmission from transmitter 130 may therefore provide both a multicast transmission message, and notification to individual members of group 105 of a reserved access timeslot for the member to use for transmission back to infrastructure 120. A transmission back to infrastructure 120 by any of mobile communication devices 110, 112, 114, 116 and 118, such as mobile communication device 110, may comprise an acknowledgement of receipt by mobile communication device 110 of the multicast message. The multicast message may require an active response in addition to an acknowledgement, for example confirmation by a user of mobile communication device 110 that the user is available to take part in a call. The confirmation message may be transmitted by mobile communication device 110 separately from the acknowledgment, so that the confirmation message may not be provided within the reserved access timeslot assigned to mobile communication device 110.

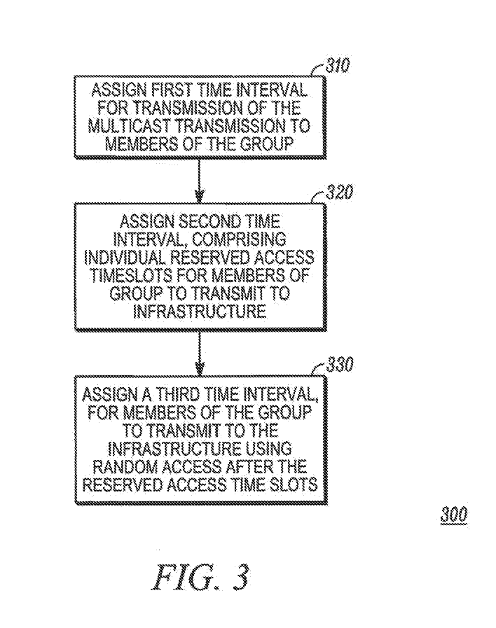

FIG. 3 shows a detailed implementation of a method 300 of assigning time intervals. At 310, infrastructure 120 assigns a first time interval, within which transmission of the multicast transmission to members of the group 105 will take place. When the multicast transmission comprises just one Payload Data Unit (PDU), then the first time interval may just be the time needed to transmit the PDU. However, the first time interval may be set to run up until a time point when the management module 140 expects the first member of group 105 to be able to transmit a reserved access response. When multiple PDUs need to be transmitted, the first time interval may be set to accommodate all of the PDUs. In other embodiments, when multiple PDUs need to be transmitted, the first time interval may be set to accommodate some of the PDUs, with other PDUs transmitted in later time intervals, as explained in connection with later FIGs.

At 320, infrastructure 120 assigns a second time interval, following the first time interval. The second time interval comprises individual reserved access timeslots, within which the members of the group 105 may transmit to the infrastructure 120, and infrastructure 120 also assigns those timeslots. At 330, infrastructure 120 also assigns a third time interval, as the time period when members of the group may transmit to the infrastructure using random access. The third time interval may be of a predetermined duration, and occurs after the second time interval. When the infrastructure 120 assigns the second time interval, at 320, for individual reserved access timeslots, each individual reserved access time slot may be assigned to only one member of group 105. At 320 in the method of FIG. 3, infrastructure 120 may assign an individual reserved access time slot to each member of group 105. As a consequence, all members of group 105 have an individual reserved access time slot available for their transmissions to infrastructure 120, during the second time interval. The second time interval duration may exceed the third time interval duration.

The two-way radio communication system 100 may be a TETRA communication system. Management module 140 may comprise a SwMI of the TETRA communication system. Thus the TETRA SwMI may assign the first time interval, the second time interval, the reserved access timeslots, and the third time interval as shown in FIG. 3. The SwMI may schedule the first reserved access time slot to fall after the minimum response time for a member of the group 105.

The method of FIG. 3 may provide any of several possible advantages. It may protect the air interface at the transmitter entity, and/or the air interface at the receiving entity, where both the infrastructure 120 and each group member may at various times be a transmitting entity and a receiving entity. A more rapid response to a multicast transmission may be enabled. The method may allow the aggregation of multiple responses, from multiple protocol layers, into a reduced number of separate PDUs, in comparison to known methods. There is also a potential reduction in bandwidth for re-transmissions. Finally, there may be reduced demand on a random access channel, such as the control channel.

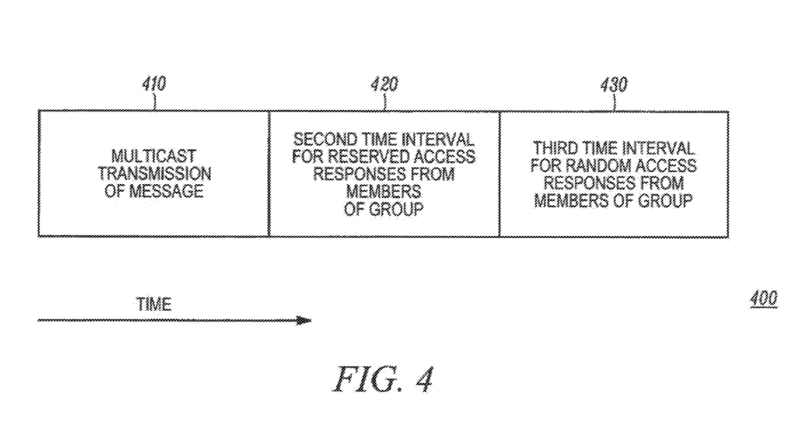

FIG. 4 is a schematic of one example of the timing of signal transmission periods in accordance with some embodiments. The schematic of FIG. 4 illustrates the first, second and third time intervals assigned in accordance with the method of FIG. 3. The progression of time is from left to right in FIG. 4.

The first time interval 410 is the time interval for transmission of the multicast transmission from the infrastructure to members of the group 105, which is assigned at 310 in FIG. 3. First time interval 410 can also be considered to include any waiting time, after transmission of the multicast transmission but before the time has come when the reserved access time slot was assigned. The second time interval 420 is the time interval that is assigned at 320 in FIG. 3, and which comprises individual reserved access timeslots for members of group 105 to transmit to infrastructure 120. Finally, third time interval 430 is the time interval that is assigned at 330 in FIG. 3, for members of the group 105 to transmit to the infrastructure 120 using random access, after the reserved access time slots.

As an illustrative non-limiting example, management module 140 may assign a first time interval 410 in the range of 100-1000 ms. However, 200 ms may be a typical minimum time after the start of first time interval 410 when any of mobile communication devices 110, 112, 114, 116 and 118 would first be able to transmit to infrastructure 120. The second time interval 420 may be in the range of 100-2500 ms and the third time interval 430 in the range of 500-2500 ms. Reserved access time slots for each member of group 105, in the second time interval 420, may for example be of a duration in the range of 10-150 ms. A typical reserved access timeslot duration might be 25 ms, for a mobile communication device 110 to transmit to infrastructure 120. In an illustrative example, management module 140 may assign 250 ms in which the multicast transmission will take place. Reserved access responses from members of the group 105 will then be allowed in the time interval from 250 ms after the start of transmission until 2200 ms after the start of transmission. The potential first random access response from members of the group 105 would then be 2200 ms after the start of transmission. The time period for random access transmissions might end 4200 ms after the start of transmission. Management module 140 may balance the distribution of time between reserved and random access. This balancing may be based on the number of subscribers that will respond, and their expected coverage.

In some instances, a longer time interval for reserved access transmissions from members of the group will mean that less time must then be set aside for random access transmissions from members of the group, for any given size of group 105. This balancing may be optimised on the basis of information supplied to management module 140 by transmitter 130. This information may comprise transmitter 130's previous experience of providing comparable services, i.e. analogous multicast transmissions, and transmitter 130's knowledge of the subscribers attached, such as the members of group 105 that are currently active.

Although the first time interval 410 for multicast transmission may be up to 1000 ms, a more usual scenario is that transmitter 130 will request an application layer acknowledgment for every 4-10 PDUs transmitted, which would keep first time interval 410 to substantially less than 1000 ms. It is this feedback/acknowledgment that can enable management module 140 to decide when to perform re-transmission of PDUs of the multicast transmission, and whether to delay the start of the third time interval 430 for random access transmissions from mobile communication devices.

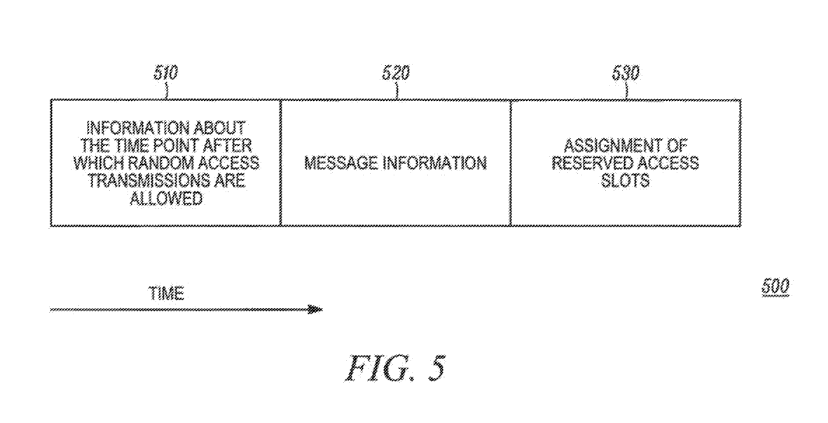

FIG. 5 is a schematic of the content of a multicast signal 500 transmitted in first time interval 410, in accordance with some embodiments. The progression of time is from left to right in FIG. 5. Transmitter 130 of infrastructure 120 transmits multicast signal 500 as a multicast transmission to all of mobile communication devices 110, 112, 114, 116 and 118, in first time period 410 of FIG. 4. First time period 410 is the time assigned at 310 in FIG. 3. In other embodiments, the three segments of multicast signal 500 may be transmitted in other sequences.

In the exemplary illustration of FIG. 5, first portion 510 comprises information about the time point after which random access transmissions are allowed. After that time point, any of mobile communication devices 110, 112, 114, 116 and 118 can attempt to transmit to infrastructure 120 using random access, for example on a control channel of two-way radio communication system 100. Second portion 520 of multicast signal 500 may comprise payload data units (PDUs) of message information, i.e. the useful payload data, which is destined for all of mobile communication devices 110, 112, 114, 116 and 118. Third portion 530 of multicast signal 500 comprises information about the reserved access time slots assigned at 320 in FIG. 3 to each of mobile communication devices 110, 112, 114, 116 and 118. The sequence of first portion 510, second portion 520 and third portion 530 is purely illustrative. First portion 510, second portion 520 and third portion 530 may be transmitted in any order. In addition, the information in first portion 510 may be appended to some or all of the signaling in portion 530, and the combined assignment information transmitted in portion 510. In this case, in some embodiments, a separate portion 530 after portion 520 may not be required.

Portion 510 informs the mobile communication devices 110, 112, 114, 116 and 118 of the time point at which the third time interval 430, assigned at 330 in FIG. 3, begins. Portion 510 may also provide information about an end time, after which mobile communication devices 110, 112, 114, 116 and 118 may no longer transmit to infrastructure 120 using random access. In this case, portion 510 is informing mobile communication devices 110, 112, 114, 116 and 118 about both the beginning and the end of the third time period 430. Portion 510 would normally be sent as a multicast transmission to all the relevant subscribers, i.e. using the same Group Short Subscriber Identity (GSSI). In the particular embodiment shown in FIG. 5, a ‘back-off’ timer instruction, indicating the time point at which the third time interval 430 begins, is being sent to each mobile communication device at the start of the signaling period. Timing this transmission at the start of the signaling period may be advantageous, in communication systems where the default behavior of any mobile communication device is to start requesting random access as soon as the message information has been transmitted. In such systems, without portion 510 being ahead of portion 520 as shown in FIG. 5, if the message information comprised multiple PDUs, then some mobile communication devices of the group would be likely to attempt random access transmissions to the infrastructure before the end of transmission of the message information.

In the embodiment of FIG. 4, a mobile communication device 110 may transmit a request to the infrastructure 120 in its reserved access timeslot in second time period 420. The request may be for re-transmission of at least one PDU of the multicast transmission message 500 that transmitter 130 transmitted in first time interval 410. This is one of the PDUs transmitted in the time slot shown as 520 in FIG. 5. Re-transmission would be needed when mobile communication device 110 did not receive all of the PDU(s) concerned. Transmitter 130 may decide to re-transmit the requested PDU after the end of third time interval 430. Compared to known arrangements, this approach may result in re-transmission of missing PDUs sooner than would have been possible with known arrangements. When a large proportion of the members of any group requests re-transmissions, those re-transmissions may all be successfully received in second time interval 420, which may be shorter than a random access time interval required in known systems to receive all requests for re-transmissions.

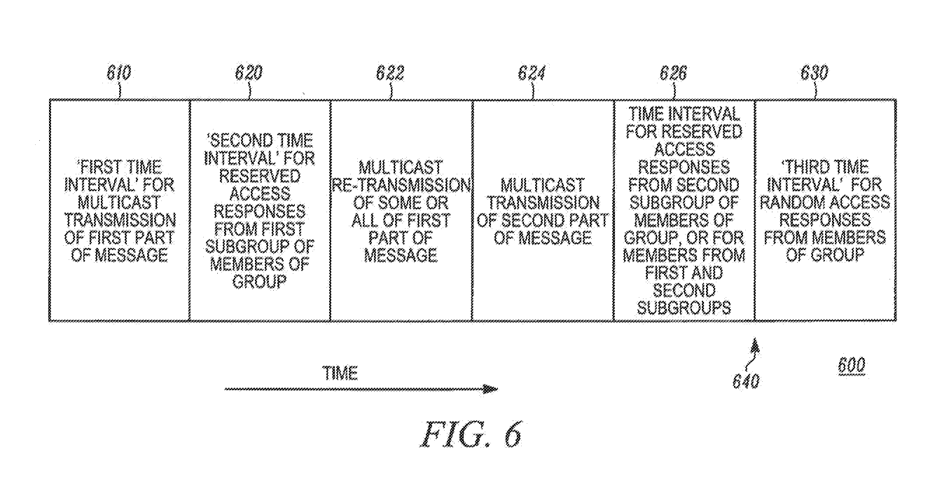

FIG. 6 is a schematic of an alternative timing of signal transmission periods in accordance with some embodiments. In the embodiment of FIG. 6, a time period for random access transmissions from members of group 105 does not follow immediately after the time period for reserved access transmissions. Instead, the ‘first’ time interval only provides time for transmission of part of the multicast transmission, and only some members of the group 105 are assigned reserved access time slots in the ‘second’ time interval. Following the second time interval, the infrastructure may re-transmit parts of the first part of the multicast transmission. Next, the infrastructure may transmit a second part of the multicast transmission. After transmission of the second part of the multicast transmission, there may be a further interval for other members of the group to make reserved access transmissions. Only after all these time periods, is an opportunity provided for members of the group to transmit to the infrastructure using random access. This sequence of transmissions may recur. The final ‘third’ time period for random access transmissions from members of the group may therefore only occur after several cycles of transmission of part of the multicast transmission, and multiple time periods, in each of which only some members of the group have reserved access time slots to transmit to the infrastructure.

In FIG. 6, transmitter 130 transmits a first part of a multicast message 500 in first time interval 610. Management module 140 of infrastructure 120 assigns first time interval 610, also assigns all the remaining time intervals shown in FIG. 6. Second time interval 620 provides an opportunity for members of a selected first subgroup of the group 105 to transmit to infrastructure 120 using reserved access slots assigned by the management module 140. The first sub-group might, for example, comprise mobile communication units 110, 112 and 114 of FIG. 1. During second time interval 620, only members of the first subgroup may transmit acknowledgments or requests for re-transmission of one or more PDUs of the first part of message 400.

First time interval 610 of FIG. 6 differs from first time interval 410 of FIG. 4 in that only a first part of the message 500 is transmitted. Second time interval 620 of FIG. 6 differs from second time interval 420 of FIG. 4 in that only members of a first subgroup of group 105 may transmit. All other members of group 105 are forbidden from transmitting with either random access or reserved access in second time interval 620. The members of group 105 that are not in the first subgroup will all either have a reserved access timeslot assigned to them for a later transmission to the infrastructure 120, or will have to wait for the random access time interval discussed below.

Time interval 622 in FIG. 6, provides an opportunity for the transmitter 130 to re-transmit any PDUs of the first part of message 500 that were requested in second time interval 620. In time interval 624, transmitter 130 transmits a second part of message 500. For example, when the payload of message 500 comprises eight PDUs, four might be transmitted in first time interval 610, and the remaining four are then transmitted in time interval 624.

A subsequent time interval is indicated at 626 in FIG. 6. Time interval 626 may be reserved just for members of a second subgroup of group 105 to transmit to the infrastructure 120, using reserved access time slots assigned by management module 140. However, time interval 626 may instead be available to members of both the first and second subgroups to transmit to infrastructure 120, using reserved access time slots assigned by management module 140.

Time intervals such as 620, 622, 624 and 626 may recur, with more than two periods being available for transmission of parts of the message 500 by transmitter 120. In this case, the management module 140 will decide on the proportion of time assigned to each of the time intervals. For example, based on experience with previous transmissions to the group 105, or based on responses to the transmissions of each part of the multicast message transmitted as shown in FIG. 6, management module 140 may assign the length of each time interval 620, 626 for reserved access and each interval 622, 624 for re-transmissions. These assignments may be dynamic, so may be re-assigned after the first time interval 610.

The final time interval 630 illustrated in FIG. 6 shows the time interval for random access transmissions to infrastructure 120 from members of group 105. This corresponds to the ‘third time interval’ assigned at 330 in FIG. 3. Third time interval 630 may provide an opportunity for members of both the first and second subgroups of group 105 to transmit to infrastructure 120. Where some members of group 105 are not included in either the first or the second subgroups, their first opportunity to request re-transmissions is in third time period 630. The time interval 630 shown in FIG. 6 corresponds to third time interval 430 in FIG. 4. Time point 640 shown on FIG. 6 indicates the start of time interval 630 for random access transmissions by all members of group 105. Transmitter 130 may indicate the start of time interval 630 to the members of all the subgroups by simply transmitting the value of time point 640. This approach permits the information about the start of the random access time interval to be signaled using the minimum of signaling payload. The transmission of just the time point 640 to the members of the subgroups may be a particularly advantageous approach when the parameter is included in an individual message to each member of group 105 assigning a reserved access slot, i.e. where the content of time periods 510 and 530 shown in FIG. 5 are combined. Transmission of just the value of time point 640 may make it easier to dynamically change the start point of the ‘third time interval’ 630 in various embodiments.

With the timing shown in FIG. 6, transmitter 130 re-transmits some or all of the PDUs of the first part of the multicast message 500 immediately after the end of second time interval 620. This approach reduces the time between the start of transmission of message 500 and the first opportunity to transmit one or more missing parts of message 500. In FIG. 6, the terms ‘first time interval’ 610, second time interval' 620 and ‘third time interval’ 630 have been used to provide consistent terminology with FIGS. 3 and 4. However, the first time interval 410 in FIG. 4 is for multicast transmission of all of the message destined for the members of group 105. The first time interval 610 is for transmission of only part of the message destined for the members of group 105.

FIG. 6 therefore shows a method whereby the infrastructure 120 assigns a first time period 610 for transmission of part of the multicast transmission to members of the group, and then assigns a second time period 620, following the first time interval 610. The second time interval 620 comprises individual reserved access timeslots when members of a first subset of the group 105 may transmit to the infrastructure. Infrastructure 120 notifies all members of the group 105 that they are only allowed to transmit to the infrastructure using random access during third time interval 630 or after a time point 640. Infrastructure 120 provides and transmits a first portion of the message 500 in the first time interval 610, and provides and transmits a second portion of the message 500 after the second time interval 620, but before the time point 640. Infrastructure 120 has the option of re-transmitting all or part of the first portion of the transmission after the second time interval 620 and before time point 640, when a member of the group 105 has not received all or part of the first portion of the transmission. As shown in FIG. 6 at 622, infrastructure 120 may re-transmit all or part of the first part of the message 500 before transmitting the second part of the message 500 at 624. However, in an alternative embodiment not shown in FIG. 6, infrastructure 120 may re-transmit all or part of the first part of the message 500 after transmitting the second part of the message 500.

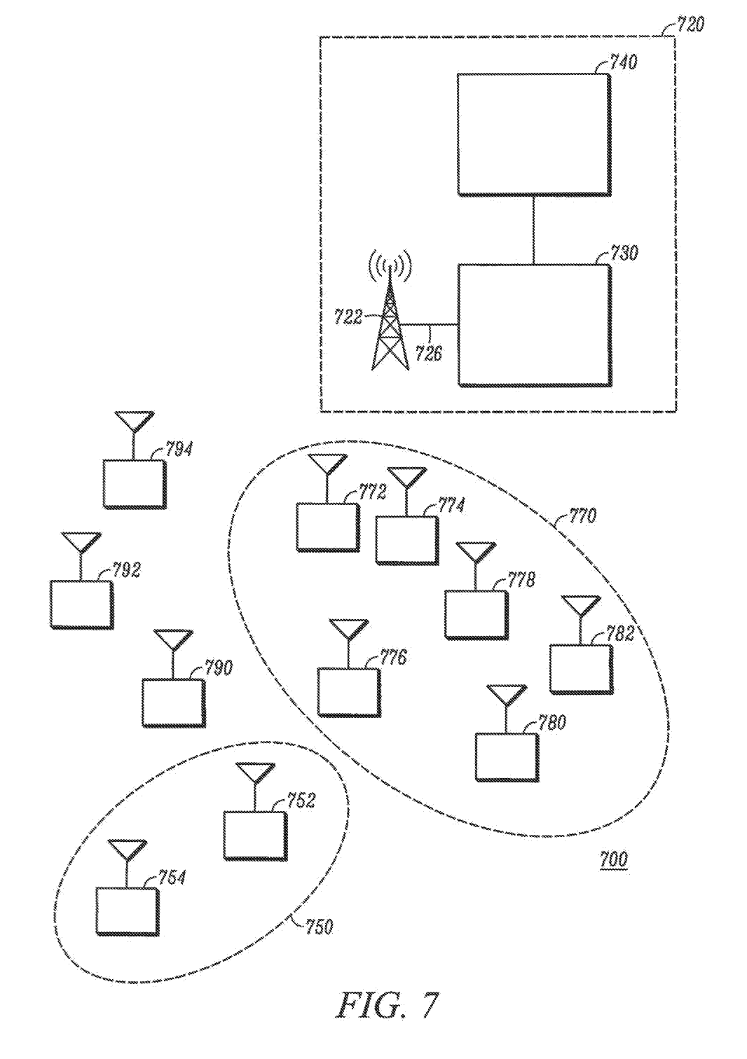

FIG. 7 illustrates sub-division of members of a group of mobile communication devices. In FIG. 7, infrastructure 720 of the two-way radio communication system 720 comprises base station 722, link 726, transmitter 730 and management module 740. Each of these elements corresponds to the similarly numbered elements in FIG. 1.

All of the mobile communication devices shown in FIG. 7, taken together, constitute a group corresponding to group 105 in FIG. 1. However, mobile communication devices 752 and 754 form subgroup 750. Mobile communication devices 772, 774, 776, 778, 780 and 782 form subgroup 770. Mobile communication devices 790, 792, and 794 are not assigned to a subgroup. Management module 740 may assign the communication devices of the two-way radio communication system 720 to the various subgroups, and may decide which mobile communication devices are not to be assigned to any subgroup. The assignment to each subgroup may be transmitted to each mobile communication device by transmitter 730, for example during time intervals 510 or 530 shown in FIG. 5.

Considering FIGS. 6 and 7 together, management module 740 may assign the mobile communication devices to transmit to the infrastructure 720 of FIG. 7 in the time intervals of FIG. 6 that are listed in the following Table.

TABLE 1
Assignment of transmission times to mobile
communication devices of FIG. 7

| Subgroup/identity of mobile | Time interval for transmission |
|---|---|
| communication devices | to infrastructure 720 |
| Mobile communication devices | Reserved access slots in ‘second |
| 752, 754 of subgroup 750 | time interval’ 620 |
| Mobile communication devices | Reserved access slots in time |
| 772, 774, 776, 778, 780, 782 of | interval 626 |
| subgroup 770 | |
| Mobile communication devices | Random access slots in ‘third |
| 790, 792 and 794 | time interval’ 630 |

As illustrated in FIG. 7, mobile communication devices 752 and 754 of subgroup 750 are generally illustrated as being further from the base station 722 than all the other mobile communication devices of the group. There may be a particular advantage to assigning mobile communication devices 752 and 754 of subgroup 750 to the second time interval 620, i.e. to the first available time interval for mobile communication devices to transmit to infrastructure 720 using reserved access. The advantage arises because the likelihood that message 500 from transmitter 730 will be received successfully by any mobile communication device of the group may fall, with increasing distance from transmitter 730. If mobile communication devices 752 and 754 successfully receive the first part of the message that is broadcast in first time interval 610, then this may be an indicator that the remaining mobile communication devices of the group have successfully received the first part of the message. Hence the success or failure of mobile communication devices 752 and 754 in receiving any or all parts of multicast transmissions from transmitter 130 may be the first indicator of whether or not re-transmission of the multicast transmission will be needed.

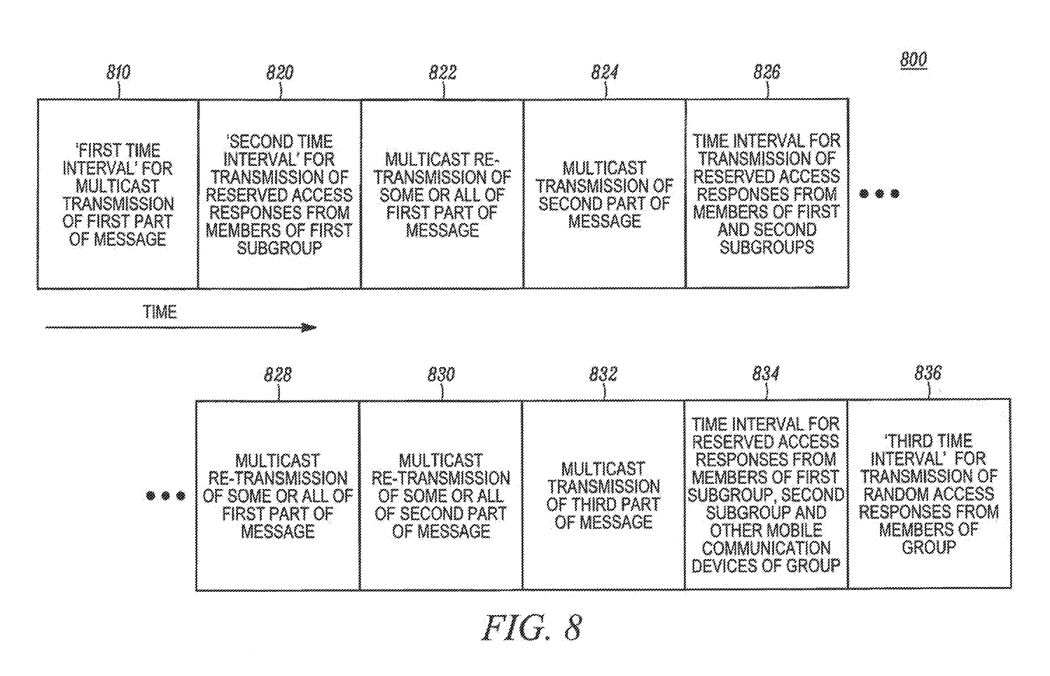

FIG. 8 illustrates a schematic of the timing of signal transmission periods in accordance with another embodiment, as an alternative to the transmission timing scheme shown in FIG. 6. In comparison with FIG. 6, it can be seen that the transmission timing scheme in FIG. 8 provides more time intervals between the end of the second time interval and the start of the third time interval, i.e. intervals 620 and 630 on FIG. 6.

In FIG. 8, the message 500 for transmission is divided into three parts. The first part of the message 500 is first transmitted by transmitter 730 in first time interval 810, and re-transmitted in time intervals 822 and 828, if required. The second part of the message 500 is first transmitted in time interval 824, and re-transmitted in time interval 830, if required. The third part of the message 500 is transmitted in time interval 832.

Second time interval 820 allows members of first subgroup 750 to transmit to the infrastructure using reserved access timeslots. Further opportunities for members of first subgroup 750 to transmit to infrastructure 720 using reserved access timeslots are provided in time intervals 826 and 834. Time interval 826 also allows members of second subgroup 770 to transmit to infrastructure 720 using reserved access timeslots. A further opportunity for members of second subgroup 770 to transmit to the infrastructure using reserved access timeslots is provided in time interval 834. Time interval 834 also provides an opportunity for mobile communication devices 790, 792 and 794 to transmit to infrastructure 720 using reserved access. The ‘third time interval’ 836 provides random access opportunities for any member of the group to transmit to infrastructure 720. In the case of two subgroups, and as an alternative to the timing scheme illustrated in FIG. 8, infrastructure 120 may assign an individual reserved access time slot only to each member of the second subgroup 770 for transmission in time interval 826. In this case, members 752 and 754 would not be able to transmit to the infrastructure during time interval 826.

In summary, message 500 may be sub-divided, and successive parts of message 500 transmitted in more than the two time intervals. In addition, group 105 may be sub-divided into more than two subgroups. One or more additional time intervals for reserved access transmissions may be provided between the end of the second time interval 620, 820 and the start of the third interval 630, 836.

Transmitter 730 of infrastructure 720 may provide information about an expected level of response to the multicast transmission of message 500. This information may be based on recent signals received from various members of the group, indicating for example that a member was not in sleep mode. The information would be provided to management module 740. Management module 740 determines the assignment 220 of reserved access time slots, and this may be based at least partly on the information from transmitter 730. This determination may be based on the information about the expected response to the multicast transmission, together with data on the number of mobile communication devices in the group. In addition or instead of the information on the size of group, the determination by management module 740 may be partly based on channel loading information.

Transmitter 730 may provide information about one or more of: a shortest time in which a response to a multicast transmission of a message from a mobile communication device can be expected; a minimum time, after which responses to the multicast transmission from mobile communication devices should be permitted using random access; a ‘response profile’ indicating how the receiver is expected to respond; and an initial estimate of a size of the group, the initial estimate comprising a probable number of mobile communication devices that can be expected to respond to the multicast transmission. The response profile may comprise a simple profile. An example of a simple profile would be to grant 3 reserved access slots after 200 ms. A more advanced profile could, for example, be to grant just a half slot for a response after 200 ms, and a further three slots at some point after 5-15 seconds, for further responses by the same mobile communication device. The response received in the half slot might be a simple acknowledgment of successful receipt of the multicast transmission. The further three slots would allow the mobile communication device to transmit a more complex or advanced response to the infrastructure 120. The response profile is an example of information that is available to a transmitter, and which may advantageously be used by the management module 140 to select and set time intervals more effectively than with known two-way radio communication systems.

Management module 740 may then, on the basis of this information and other information known to it, assign to each member of the group a reserved access timeslot, in which the member may transmit to transmitter 730. Management module 740 may assign the third time interval 430, 830 for members of the group to transmit to infrastructure 720 using random access. In the embodiments of FIGS. 6 and 8, the management module 740 would assign the various time intervals. The assignment of the time intervals is notified to the various mobile communication devices by transmitter 730.

Management module 740 and/or transmitter 730 may in addition be configured to assign an additional reserved access timeslot to any member of the group, in response to a request from that member made during a reserved access timeslot that was initially assigned to the member. So if mobile communication device 752 transmits a request during second time interval 820 for an additional reserved access timeslot, that request may be granted. Mobile communication device 752 may then transmit an acknowledgment during the reserved access time slot originally assigned to it in time interval 820. Later in time interval 820, or in another time interval 826 or 834 before time point 640 in FIG. 6, mobile communication device 752 would then also have a second reserved access time slot available. This second reserved access time slot may be used to provide further information from mobile communication device 752, or information from the user of mobile communication device 752. A user may indicate that he wishes to participate in a call or other activity, or may alternatively indicate that he does not wish to.

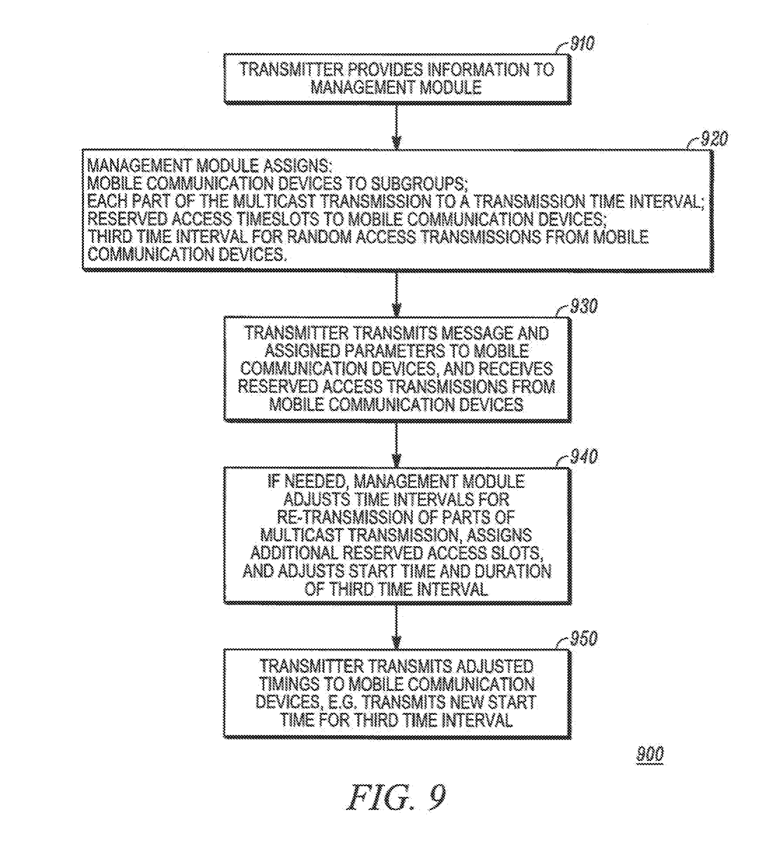

FIG. 9 shows one possible method for setting and subsequently adjusting time intervals in the two way radio system 700 of FIG. 7. At 910, transmitter 730 provides information to management module 740 about, for example, the shortest time in which a response to a multicast transmission can be expected from a mobile communication device. At 920, management module 740 sets the timings and sequence of the time intervals shown in FIG. 8. The values selected by management module 740 may be based on the information from transmitter 730, the timings of the time intervals used for previous message transmissions, and/or response times and rates observed for previous message transmissions.

At 930, transmitter 730 conveys the timings and sequence of the time intervals to the mobile communication devices. Each mobile communication device will be informed when it may make reserved access transmissions, and will be informed of the timing of the third time interval when it may make random access transmissions. Also at 930, transmitter 730 will begin to receive reserved access transmissions from mobile communication devices such as mobile communication devices 752 and 754 of subgroup 750. At 940, management module 740 may adjust the time intervals that were set at 920. This adjustment may optimize the time intervals 822, 824, 828, 830 and 832 for re-transmission of parts of multicast transmission, for example. In addition, or instead, management module 740 adjusts the start and/or duration of third time interval for random access transmissions and assigns more reserved access slots. At 950, transmitter 950 transmits the adjusted timings to the members of the group.

The embodiment of FIG. 1 included transmitter 130, which may transmit the multicast message 500 to the group. However, in some embodiments, the transmitter may not be part of the infrastructure, and could be another mobile communication device. Wherever the transmitter is located, it utilizes the infrastructure to determine the time intervals described above. The various time intervals employed in embodiments of the invention are ultimately set by management module 140. However, transmitter 130, or another transmitter located elsewhere, may supply information to management module 140, for use in setting the time intervals. The information listed above as being supplied by the transmitter was: a shortest time in which a response can be expected; a minimum time, after which random access should be permitted; an initial estimate of a size of the group; a response profile. However, this list is not limiting. The transmitter may supply all of these items of information, a subset of them, or additional different items of information that the management module 140 can utilize in selecting and setting the durations of the time intervals.

In summary, management module 740 and/or transmitter 730 are operable to receive transmissions from members of the group in the various reserved access time slots. Management module 740 and/or transmitter 730 arrange for the re-transmission of all or part of the original multicast transmission. Management module 740 and/or transmitter 730 may be configured to only provide re-transmission when infrastructure 720 receives a transmission from at least one member of the group, requesting a re-transmission. In this embodiment, when no reply is received from a particular mobile communication device in a reserved access timeslot assigned to that mobile communication device, the management module 740 and/or transmitter 730 would not re-transmit any part of the message 500. In such a situation, the assumption may be that the particular member of the group either has failed to successfully receive any part of the multicast transmission, or is out of range, or is switched off. In some embodiments, members of the group may simply be required to transmit a ‘null’ PDU in their reserved access time slot, in order to request re-transmission. This allows the management module 740 and/or transmitter 730 to know which members of group 705 did actually receive the original multicast transmission. Management module 740 may update a list of mobile communication devices that are in coverage of transmitter 730, based on various responses, requests and/or null-PDUs received from mobile communication devices in the reserved access timeslots.

The method may comprise the transmission of a variety of multicast transmissions. In some embodiments, the multicast transmission comprises a group based call-out request. This request may go to tens or even hundreds of mobile communication devices. In an illustrative example, the call out request may comprise a request for users of two-way radios that are near an emergency scene to assist at the scene. In some embodiments, the multicast transmission comprises a group based text or image.

When members of the group are assigned reserved access time slots, or informed that they may first reply using random access in the third time interval, those assignments may only relate to responses to the multicast transmission commenced in first time interval 610, 810. Those responses may be acknowledgements or requests for re-transmission. The mobile communication devices may be permitted to commence random access transmissions for other purposes at other times than the reserved and random access time slots. For example, all mobile communication devices may be allowed to commence an emergency transmission at any time, whatever the assignment of time intervals by management module 740. In addition, the mobile communication devices of the group may or may not be allowed to initiate a group call, even in a time period where they have not been assigned a reserved access or random access timeslot for responding to the multicast transmission.

When the multicast transmission comprises data, an acknowledgement from a group member may be subject to significant delay. The multicast transmission may provide a data message, such as a Short Data Service message. A mobile communication device would then provide an application-level-response or report. In TETRA, this might be a ‘TL-REPORT’ as an acknowledgment. The application-level-response may not be available until more than 200 ms has elapsed since the start of transmission of the multicast transmission. Such a delay may be typical when the mobile communication device is on a PC. Mobile communication devices of known communication systems transmit application-level-reports using random access, because of the variability in their transmission time point. The embodiments described above allow application-level-reports to be sent using reserved access (RESV).

A short data (SD) multicast message can be sent out based on ‘preferred implementation’. The management module 740 can then grant reserved logical link control (LLC) level resources to all the relevant receivers, in order to determine if the PDU needs to be retransmitted, potentially with lower bandwidth. In some embodiments, not all mobile communication devices need to send an acknowledgement. Instead, the approach may be to focus on the subscribers with the most interesting Received Signal Strength Indication (RSSI) values. An advantage may be that more efficient dynamic multicast transmission can be achieved. This alone may provide a significant improvement. A factor of four improvement in multicast efficiency has been provided by some embodiments, with less retransmission.

Some embodiments provide efficient LLC-level based retransmission of multicast PDUs. Management module 740 can transmit the PDU over LLC. This will allow the SwMI to grant an LLC-level request per group member, in order to determine which segments should be retransmitted. This may serve to enhance the efficiency of the acknowledged multicast service.

Where the multicast transmission is a SD multicast service, for example a text or image, transmitter 130 may transmit the relevant PDUs and request an application layer acknowledgement for every 4-10 PDUs. The acknowledgment may be from only a subgroup of the mobile communication devices, as explained in connection with FIG. 6. Transmitter 120 can use the feedback to determine how the infrastructure should perform a retransmission of the SD multicast service. For example, the feedback received in second time interval 620 will lead to a decision on whether to re-transmit some or all of the first part of the message in time interval 624.

Infrastructure 120 may place significant emphasis on what it has ‘learned’ about the group, based on previous attempts to send a multicast message. The number of requests for re-transmissions that are received may be used to plan the timing of time intervals for future transmissions. For example, the duration of second time interval 620, 820 may be set on the basis of particular numbers of requests for re-transmissions received when previous multicast messages were sent. Alternatively, the method of FIG. 6 may be selected in preference to that in FIG. 4, on the basis of ‘learned’ behavior, i.e. previous levels and types of responses from members of group 105.

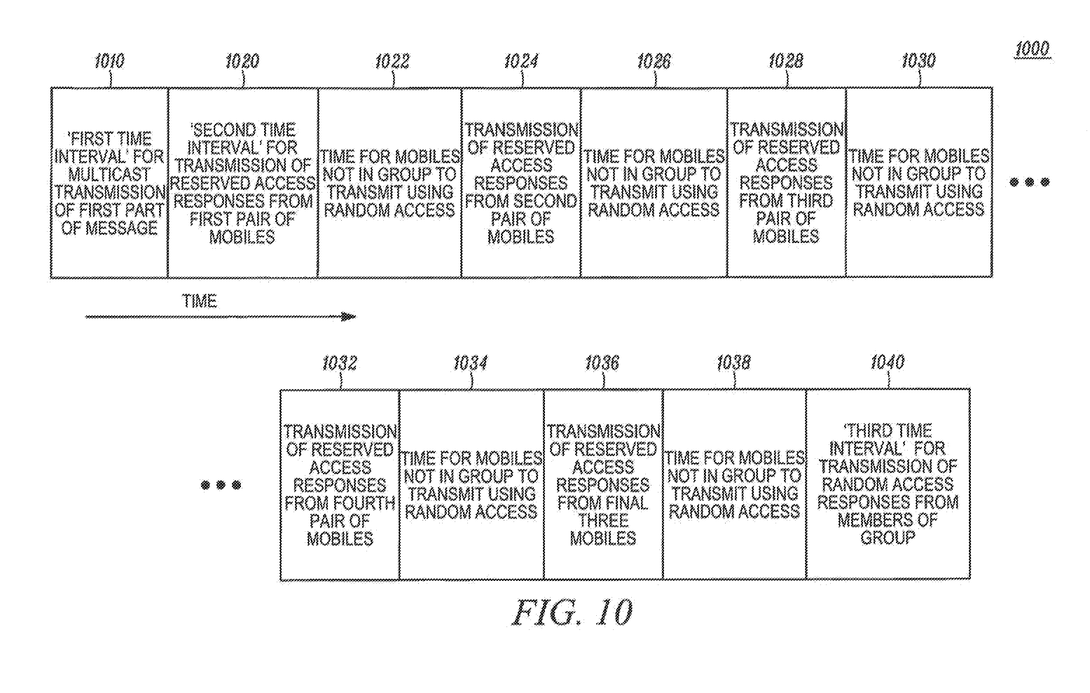

Management module 740 may use information about the importance of the multicast message, when assigning the time intervals for transmission of the multicast message and the various transmissions from mobile communication devices. FIG. 10 illustrates an embodiment where this has been applied. FIG. 10 illustrates a transmission timing scheme 1000. With transmission timing scheme 1000, timing intervals have been assigned that allow other mobile communication devices, which are not in the group shown in FIG. 7, to communicate with infrastructure 720 in a structured way.

All the time intervals shown in FIG. 10 are assigned by management module 740 of FIG. 7. The timing diagram of FIG. 10 has multiple time periods assigned for mobile communication devices that are not in the group shown in FIG. 7 to communicate with the infrastructure 720. In those time periods, no mobile communication devices from the group shown in FIG. 7 may transmit to the infrastructure.

With the transmission timing schemes of FIGS. 6 and 8, the management module 740 may only assign some of the reserved access slots to the of timing intervals 620 and 820 at the time of transmission of the first part of message 500 in first time interval 610, 810. Part way through the first time interval 610, 810, management module 740 may decide on the assignment of other reserved access time slots to members of the first subgroup, and transmitter 730 will then notify the members of the first subgroup that are affected. This allows management module 740 to respond dynamically within each time interval that is reserved for reserved access transmissions, for example in dependence on the earliest transmissions received from members of the first subgroup at the start of first time interval 620, 820. The assignment of reserved access time slots in the other time intervals for reserved access, such as time interval 628, may similarly be partly done before the start of the time interval, with further assignments decided and transmitted during the timing interval.

In the embodiment of FIG. 10, message 500 is transmitted in first time interval 1010, perhaps in the communication system of FIG. 7. Immediately after first time interval 1010, a second time interval 1020 allows just two mobile communication devices of the group to transmit to the infrastructure 720. The two mobile communication devices may, for example, be mobile communication devices 752, 754. A time period 1022 then allows mobile communication devices that are not in the group shown in FIG. 7 to transmit to the infrastructure 720 using random access. Spaced time intervals 1024, 1028, and 1032 provide reserved access time slots for, respectively, other pairs of mobile communication devices to transmit to the infrastructure 720. For example, mobile communication devices 772, 774 may be allowed to transmit during time interval 1024, mobile communication devices 776, 778 may be allowed to transmit during time interval 1028, and mobile communication devices 780, 782 may be allowed to transmit during time interval 1032. Mobile communication devices 790, 792 and 794 may be allowed to transmit during time interval 1036. Time intervals 1026, 1030, 1034 and 1038 are interleaved between time intervals 1024, 1028, 1032 and 1036, and provide opportunities for mobile communication devices that are not in the group shown in FIG. 7 to transmit to the infrastructure 720 using random access. Time interval 1040 is the ‘third time interval’, for transmission of random access responses from members of group to the infrastructure 720.

If the message 500 transmitted in first time interval 1010 is of low priority, then the majority of transmission time may be assigned for mobile communication devices that are not in the group to transmit to the infrastructure 720 using random access. In a numerical example, which is illustrative and not limiting, management module 740 may assign a total time period of one second for each cycle comprising a time interval for two members of the group to transmit with reserved access, and a time interval for mobile communication devices not in the group to transmit using random access. So the total time for time intervals 1022 and 1024 would be one second. The next second would be taken up by time intervals 1024 and 1026. In this example, a second interval 1020 for two members of the group to transmit with reserved access may be of the order of 200 ms. The remaining 800 ms would be the time interval 1022 for mobile communication devices not in the group to transmit using random access. The 200 ms and 800 ms time intervals are signaled separately, and can be kept to within a resolution of 14 ms. When, in contrast, the message 500 is high priority, then a greater proportion of the time after first time interval 1010 may be assigned by management module 740 for members of the group to transmit using reserved access. In addition, the total time until time interval 1040 may be shortened, in order that responses from members of the group be received sooner. Management module 740 is in a position to decide on the importance of message 500, since it has access to the PDUs of message 500.

The total time for all of the signaling shown in either FIG. 8 or FIG. 10 is set by the management module 740 of the infrastructure 720. Considering the time intervals shown in FIGS. 8 and 10, the time assigned to each time interval and the total time for all the signaling, may be set in dependence on one or more of at least the variables shown in Table 2 below.

TABLE 2
Variables affecting the time interval assignment in FIGS. 8 and 10

| Variable | Effect of change to the variable |
|---|---|
| The number | More devices may require more random access and |
| of mobile | reserved access timeslots. More devices may mean |
| communication | more clashes in the final random access transmission |
| devices | period, hence requiring a longer period for random |
| | access. |
| Signal | Poorer conditions may mean more requests for re- |
| propagation | transmission, and more re-transmissions. |
| conditions | |
| Proportion | Reserved access requests may, for example, only be |
| of reserved | accommodated at rate of 1 slot/second, if on a TETRA |
| access | voice channel. Random access may, for example, only |
| requests | be accommodated at rate of 18 slots/second on the |
| | inbound control channel. So more time may be needed |
| | if a greater proportion of reserved access slots |
| | assigned. |
| Number of | Longer messages take longer to transmit, and require |
| PDUs in | signal propagation conditions to be stable for longer, |
| message for | in order to be received successfully. |
| transmission | |

The third row of Table 2 considers the 1 slot/second voice channel and 18 slots/second control channel, as an illustrative, non-limiting example. Each of these channels may also permit the assignment of half slots, raising the rates to 24 half-slots/second and 36 half-slots/second. If a 50 kHz Quadrature Amplitude Modulation (QAM) multi-slot packet data channel is available with four opportunities per slot, then there may be as many as 2×4×18 or 2×2×4×18 random access opportunities per second. In general, a control channel may provide of the order of 18 times more opportunities than voice channels, and a QAM channel provide 8 times more opportunities than a control channel. So the total time required for signalling depends on the proportion of signalling that can be done either as random access or reserved access, and on the types of channel available for that signalling. A further consideration is whether the management module 740 delays some reserved access time slots, in order to allow a user of the mobile communication device to transmit later. In order to do this, the management module 740 may assign a slot or half slot within a period of less than 2 seconds, for the mobile communication device to either acknowledge receipt of the multicast transmission, or request a re-transmission. If the first time interval is only 200 ms, then the mobile communication device may be allocated a reserved access slot at some point 200-1000 ms after the start of the transmission from the infrastructure 720. The same mobile communication device may also be assigned several slots around 5-15 seconds later, in case the user wishes to signal to the infrastructure 720.

Management module 740 may set various durations for the time intervals of FIGS. 6, 8 and 10, in dependence on information from the transmitter 730 and known capabilities of the infrastructure. The following timings are purely illustrative, and non-limiting. Management module 740 may set a first time interval for a multicast transmission in the range of 100-1000 ms, followed by a second time interval in the range 100-500 ms, if a reserved access response from just one mobile communication device is needed. However, a time interval of 100-500 ms for a further reserved access response from the mobile communication device may be set to begin anywhere up to 15000 ms after the start of the multicast transmission, if a further response after user interaction with the mobile communication device is expected. Such interaction may be, for example, a user pressing a ‘push-to-talk’ button. If reserved access responses from up to 10 mobile communication devices are needed, then the first time interval may remain at 100-1000 ms, but the second time interval may be in the range 200-5000 ms. Another time interval of 200-5000 ms for further reserved access responses from the mobile communication devices, relying on a user action, may be set to begin anywhere up to 15000 ms after the start of the multicast transmission. If there are up to 100 mobile communication devices, the first time interval may remain at 100-1000 ms. However, the second time interval may be 2000-30000 ms. Another time interval of 2000-60000 ms for further reserved access responses from the mobile communication devices, relying on a user action, may be set to begin anywhere up to 30000 ms after the start of the multicast transmission. If reserved access responses from more than 100 users are expected, then the users are grouped, and appropriate time intervals may be set as for the groups of up to 10 and up to 100 mobile communication devices. After the final reserved access time interval, in each case, there will be a third time interval for random access responses from mobile communication devices. The third time interval may be of 200-2500 ms.

In addition to the method already described, a two-way radio communication system 700 is thus also provided, together with a group of mobile communication devices. The infrastructure 720 is operable to: provide a multicast transmission, for transmission to members of the group of mobile communication devices; assign 310 a first time interval 410 for transmission of the multicast transmission to members of the group; assign 320 a second time interval 420 for the members of the group to transmit to the infrastructure, and assign reserved access timeslots in the second time interval 420 to members of the group, the second time interval 420 occurring after the first time interval 410; and assign 330 a third time interval 430, for members of the group to transmit to the infrastructure 720 using random access, the third time interval 430 occurring after the second time interval 420.

Each member of the group of mobile communications devices is operable to: transmit to the infrastructure 720 during an assigned reserved access timeslot, when a reserved access timeslot has been assigned to the member of the group; and transmit to the infrastructure 720 using random access during the third time interval 430, when a reserved access timeslot has not been assigned to the member of the group.

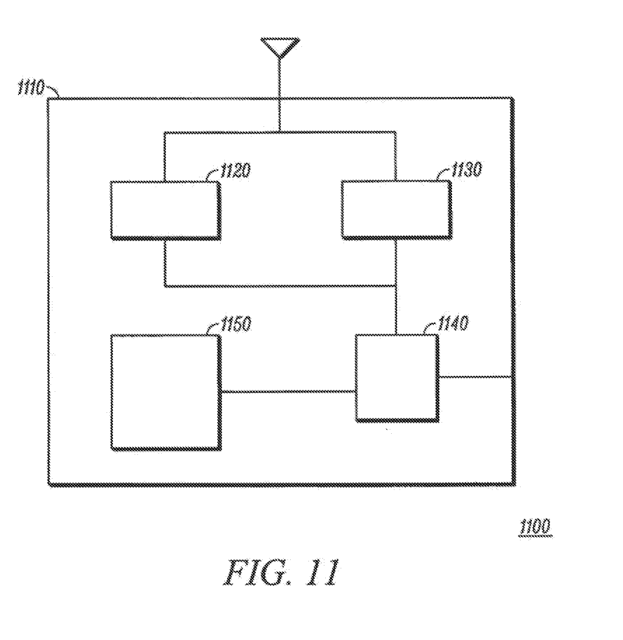

FIG. 11 illustrates a mobile communication device 1100 configured to operate in a two-way radio communication system 700. Mobile communication device 1100 may correspond to any of the mobile communication devices illustrated in FIGS. 1 and 7. Within main body 1110 of mobile communication device 1100 are receiver 1120 and transmitter 1130 (which together may form a transceiver). Processor 1140 controls mobile communication device 1100, and may carry out the operations described below. User interface 1150 may be mounted on the front surface of mobile communication device 1100, and may comprise a touch screen or other user-actuated component.

Mobile communication device 1100 is operable to: receive a multicast transmission 500 from an infrastructure 720 of the two-way radio communication system 700; to receive an assignment of a reserved access timeslot for its own transmission to the infrastructure 720, the reserved access timeslot being after at least part of the multicast transmission 500 from the infrastructure; and receive notification of a time interval 430 for random access transmission to the infrastructure 720, the time interval 430 for random access transmission being after the reserved access timeslot. Mobile communication device 1100 is further operable to: transmit to the infrastructure 720 during an assigned reserved access timeslot, when a reserved access timeslot has been assigned to the mobile communication device; and transmit to the infrastructure using random access during the time interval 430, when a reserved access timeslot has not been assigned to the mobile communication device 1100.

Mobile communication device 1100 may transmit an acknowledgement of receipt of the multicast transmission 500, when mobile communication device 1110 does not require a re-transmission of the multicast transmission 500. Mobile communication device 1100 may transmit a request for re-transmission of the multicast transmission 500, when the mobile communication device 1100 has not successfully received all of the multicast transmission 500.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of controlling responses from mobile communication devices in a two-way radio communication system, the two-way radio communication system comprising an infrastructure, the method comprising the infrastructure:
providing a multicast transmission, for transmission to members of a group of mobile communication devices;
assigning a first time interval for transmission of the multicast transmission to the members of the group;
assigning a second time interval for the members of the group to transmit to the infrastructure, and assigning reserved access timeslots in the second time interval to members of the group, the second time interval occurring after the first time interval;
assigning a third time interval for members of the group to transmit to the infrastructure using random access, the third time interval occurring after the second time interval.

2. The method of claim 1, further comprising the infrastructure assigning an individual reserved access time slot to each member of the group, whereby all members of the group have an individual reserved access time slot available in the second time interval for transmissions to the infrastructure.

3. The method of claim 1, further comprising the infrastructure:
assigning reserved access timeslots only to members of a subgroup of the group, whereby only members of the subgroup have an individual reserved access time slot available in the second time interval for transmissions to the infrastructure; and
notifying members of the group that are not in the subgroup, that those members may not transmit to the infrastructure until the third time interval for random access transmissions.

4. The method of claim 1, wherein:
the second time interval exceeds the third time interval.

5. The method of claim 1, further comprising the infrastructure:
transmitting a first portion of the multicast transmission in the first time interval; and
after the second time interval, but before the third time interval, transmitting a second portion of the multicast transmission, and re-transmitting all or part of the first portion of the transmission.

6. The method of claim 5, further comprising the infrastructure:
re-transmitting all or part of the first portion of the multicast transmission before transmitting the second portion of the multicast transmission.

7. The method of claim 5, further comprising:
the infrastructure assigning reserved access time slots to members of a second subgroup of the group, for reserved access transmission to the infrastructure after transmission of the second portion of the multicast transmission and before the third time interval.

8. The method of claim 1, further comprising:
the infrastructure delaying the start of the third time interval, in response to a transmission received from at least one member of the group during the second or a subsequent time interval.

9. The method of claim 1, further comprising:
a transmitter of the infrastructure providing information about an expected response to the multicast transmission, the information being provided to a management module of the infrastructure; and
the management module determining the assignment of reserved access time slots using:
the information about the expected response to the multicast transmission; and
data on the number of mobile communication devices in the group of mobile communication devices and/or channel loading information.

10. The method of claim 9, further comprising:
the transmitter providing information about one or more of:
a shortest time in which a response to a multicast transmission from a mobile communication device can be expected;
a response profile indicating how at least one mobile communication device is expected to respond;
a minimum time, after which random access responses to the multicast transmission from mobile communication devices should be allowed;
an initial estimate of a size of the group, the initial estimate comprising a probable number of mobile communication devices that can be expected to respond to the multicast transmission;
the management module:
assigning to at least some members of the group a reserved access timeslot, in which the member may transmit to the transmitter;
assigning the third time interval for members of the group to transmit to the infrastructure using random access.

11. The method of claim 9, further comprising the infrastructure:
dividing the multicast transmission into a first part for transmission in the first time interval, and a second part for transmission after the second time interval but before the third time interval;
assigning some members of the group to a first subgroup, and assigning reserved access slots to the members of the first subgroup in the second time interval;
assigning other members of the group to a second subgroup, and assigning reserved access slots to the members of the second subgroup, the reserved access slots for the members of the second subgroup occurring after transmission of the second part of the multicast transmission, but before the third time interval;
dynamically notifying, to members of the group, a re-timing of the third time interval, in dependence on transmissions received from members of the first and/or second sub-groups that request re-transmission of the first and/or second parts of the multicast transmission.

12. The method of claim 1, further comprising:
the infrastructure assigning an additional reserved access timeslot to a member of the group, in response to a request from the member made during a reserved access timeslot initially assigned to the member.

13. The method of claim 1, further comprising the infrastructure:
receiving transmissions from members of the group of mobile communication devices in the reserved access time slots; and
re-transmitting the multicast transmission, if the infrastructure receives a request for re-transmission from at least one member of the group.

14. The method of claim 1, wherein:
the multicast transmission comprises a group based call-out request and/or a group based text or image.

15. The method of claim 1, wherein:
the two-way radio communication system is a TETRA communication system; and
a Switching and Management Infrastructure (SwMI) of the TETRA communication system assigns the first time interval, the second time interval, the reserved access timeslots, and the third time interval.

16. The method of claim 1, wherein:
the infrastructure schedules the first reserved access time slot to fall after the minimum response time for a member of the group; and
the infrastructure assigns reserved access time slots of a duration in the range of 10-150 ms to each member of the group.

17. The method of claim 2, wherein:
the first time interval is in the range of 100-1000 ms;
the second interval interval is in the range of 200-5000 ms;
the third time interval is in the range of 200-2500 ms.

18. The method of claim 1, further comprising the infrastructure:
transmitting information to members of the group about the third time interval; and
transmitting an assignment of a reserved access timeslot to each member of the group that has been assigned a reserved access timeslot.

19. A two-way radio communication system, the two-way radio communication system comprising an infrastructure and a group of mobile communication devices:
the infrastructure operable to:
provide a multicast transmission, for transmission to members of the group of mobile communication devices;
assign a first time interval for transmission of the multicast transmission to members of the group;
assign a second time interval for the members of the group to transmit to the infrastructure, and assign reserved access timeslots in the second time interval to members of the group, the second time interval occurring after the first time interval;
assign a third time interval, for members of the group to transmit to the infrastructure using random access, the third time interval occurring after the second time interval; and
at least one member of the group operable to:
transmit to the infrastructure during an assigned reserved access timeslot, when a reserved access timeslot has been assigned to the member of the group;
transmit to the infrastructure using random access during the third time interval, when a reserved access timeslot has not been assigned to the member of the group.

20. A mobile communication device configured to operate in a two-way radio communication system, the mobile communication device being operable to:
receive a multicast transmission from an infrastructure of the two-way radio communication system;
receive an assignment of a reserved access timeslot for the mobile communication device to transmit to the infrastructure, the reserved access timeslot being after at least part of the multicast transmission from the infrastructure;
receive notification of a time period for random access transmission to the infrastructure, the time period for random access transmission being after the reserved access timeslot;
transmit to the infrastructure during an assigned reserved access timeslot, when a reserved access timeslot has been assigned to the mobile communication device;
transmit to the infrastructure using random access during the time period for random access transmission, when a reserved access timeslot has not been assigned to the mobile communication device.

21. The mobile communication device of claim 20, further operable to transmit to the infrastructure of the two-way radio communication system, in the reserved access timeslot:
an acknowledgement of receipt of the multicast transmission, when the mobile communication device does not require a re-transmission of the multicast transmission; and
a request for re-transmission of the multicast transmission, when the mobile communication device has not successfully received all of the multicast transmission.
